(19) United States
(12) Patent Application Publication
(10) Pub. No.: US 2022/0332906 A1
(43) Pub. Date: Oct. 20, 2022

(54) TRANSPARENT ANTIBACTERIAL PLASTIC FILM AND METHOD FOR MANUFACTURING THE SAME

(71) Applicant: NAN YA PLASTICS CORPORATION, TAIPEI (TW)

(72) Inventors: TE-CHAO LIAO, TAIPEI (TW); CHUN-CHE TSAO, TAIPEI (TW); Chen-Ho Lai, TAIPEI (TW)

(21) Appl. No.: 17/516,788

(22) Filed: Nov. 2, 2021

(30) Foreign Application Priority Data
Apr. 20, 2021 (TW) 110114067

(51) Int. Cl. C08J 5/18; C08J 9/00; C08L 67/00; C08J 3/22

(52) U.S. Cl. CPC C08J 5/18; C08J 9/008; C08L 67/00; C08J 3/22; C08J 2333/04; B82Y 30/00

(57) ABSTRACT

A transparent antibacterial plastic film and a method for manufacturing the same are provided. The transparent antibacterial plastic film includes a polyester material and an antibacterial composite dispersed in the polyester material. A refractive index of the antibacterial composite ranges from 1.46 to 1.66. The method for manufacturing the transparent antibacterial plastic film includes steps of: mixing the polyester material and the antibacterial composite to form antibacterial masterbatches, and using the antibacterial masterbatches to form the transparent antibacterial plastic film. A refractive index of the antibacterial composite ranges from 1.46 to 1.66.

### CROSS-REFERENCE TO RELATED PATENT APPLICATION

This application claims the benefit of priority to Taiwan Patent Application No. 110114067, filed on Apr. 20, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a transparent antibacterial plastic film and a method for manufacturing the same, and more particularly to a transparent antibacterial plastic film made from a polyester material and a method for manufacturing the same.

### BACKGROUND OF THE DISCLOSURE

A polyester material not only has an excellent bending strength and an excellent heat distortion temperature, but is also nontoxic and recyclable. Therefore, the polyester material can be extensively applied in many fields and used in various applications. For example, a packaging material of fruits and vegetables, a protective mask used by medical staff, or a screen protector can be made from the polyester material.

In response to recent pandemic outbreaks, people all over the world are paying great attention to public hygiene and adopting personal protective measures. Accordingly, numerous efforts have been made to enable a plastic material to have an antibacterial effect, so that bacteria growing on a surface of the plastic material can be killed or inhibited within a period of time, thereby achieving the antibacterial effect. Compared to conventional physical or chemical disinfection methods, using antibacterial plastic materials with a long-acting property can provide a better antibacterial effect.

Currently, most of the antibacterial plastic materials contain organic antiseptics. However, the organic antiseptics have low heat resistance, and are prone to crack and generate volatile substances under high temperature. The volatile substances are harmful to the human body and the environment. Therefore, use of such antibacterial plastic materials is not appropriate for food packaging or products that may come in contact with the human body.

In addition, a processing temperature (270° C. to 290° C.) of the polyester material is higher than a processing temperature (170° C. to 240° C.) of a polyethylene material or a polypropylene material. As such, the antiseptic added into the polyester material needs to have an appropriate heat resistance in order to endure the processing temperature. Furthermore, after adding the antiseptic, a transmittance, a haze, and a refractive index of the polyester material will be changed. Therefore, a conventional antibacterial polyester material still has room for improvement.

### SUMMARY OF THE DISCLOSURE

In response to the above-referenced technical inadequacies, the present disclosure provides a transparent antibacterial plastic film and a method for manufacturing the same.

In one aspect, the present disclosure provides a transparent antibacterial plastic film. The transparent antibacterial plastic film includes a polyester material and an antibacterial composite dispersed in the polyester material. A refractive index of the antibacterial composite ranges from 1.46 to 1.66.

In certain embodiments, a particle size of the antibacterial composite ranges from 50 nm to 400 nm.

In certain embodiments, based on a total weight of the transparent antibacterial plastic film being 100 wt %, an amount of the antibacterial composite ranges from 0.1 wt % to 2 wt %.

In certain embodiments, the antibacterial composite includes a nanopowder and an antiseptic. The antiseptic is an inorganic antiseptic.

In certain embodiments, the nanopowder is selected from the group consisting of: sodium silicate, sodium aluminosilicate, calcium aluminosilicate, and aluminum phosphate.

In certain embodiments, the antiseptic contains at least one of silver, zinc, copper, and titanium as a component.

In certain embodiments, based on a total weight of the antibacterial composite being 100 wt %, the antiseptic contains 0 wt % to 10 wt % of silver, 0 wt % to 50 wt % of zinc, 0 wt % to 30 wt % of copper, and 0 wt % to 10 wt % of titanium.

In certain embodiments, a haze of the transparent antibacterial plastic film is lower than or equal to 2.2%, a transmittance of the transparent antibacterial plastic film is higher than or equal to 88%, and a refractive index of the transparent antibacterial plastic film ranges from 1.5 to 1.9.

In another aspect, the present disclosure provides a method for manufacturing a transparent antibacterial plastic film The method includes steps of: mixing a polyester material and an antibacterial composite to form antibacterial masterbatches, and using the antibacterial masterbatches to form the transparent antibacterial plastic film. A refractive index of the antibacterial composite ranges from 1.46 to 1.66.

In certain embodiments, the method further includes a step of: sintering a nanopowder and an antibacterial precursor to form the antibacterial composite. The antibacterial composite includes the nanopowder and an antiseptic. The antiseptic is formed from the antibacterial precursor. The antiseptic contains a metal component that contained in the antibacterial precursor.

Therefore, in the transparent antibacterial plastic film and the method for manufacturing the same provided by the present disclosure, by virtue of “the antibacterial composite being dispersed in the polyester material” and “the refractive index of the antibacterial composite ranging from 1.46 to 1.66”, the transparent antibacterial plastic film can simultaneously have an antibacterial effect and its original optical properties.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic cross-sectional view of a transparent antibacterial plastic film according to the present disclosure;

FIG. 2 is a flowchart of a method for manufacturing the transparent antibacterial plastic film according to the present disclosure;

FIG. 3 is a schematic cross-sectional view showing the transparent antibacterial plastic film being applied on a substrate according to the present disclosure; and

FIG. 4 is a schematic cross-sectional view of a transparent antibacterial substrate according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### Transparent Antibacterial Plastic Film

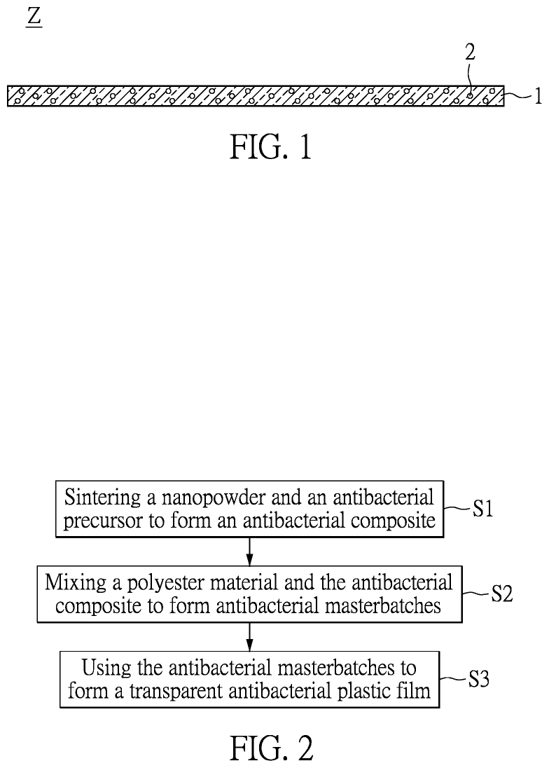

Referring to FIG. 1, a first embodiment of the present disclosure provides a transparent antibacterial plastic film Z. The transparent antibacterial plastic film Z includes a polyester material 1 and an antibacterial composite 2. The antibacterial composite 2 is uniformly dispersed in the polyester material 1.

In an exemplary embodiment, the transparent antibacterial plastic film Z is a single-layered plastic film The antibacterial composite 2 has a good heat resistance to endure a processing temperature of the polyester material 1. Therefore, the antibacterial composite 2 can be directly added into the polyester material 1, such that the transparent antibacterial plastic film Z can be mass manufactured through a simple process.

Generally, after adding a certain quantity of the antibacterial composite, optical properties (such as haze, transmittance, and refractive index) of the transparent antibacterial plastic film may be negatively influenced. In order to maintain the original optical properties of the transparent antibacterial plastic film, components, a particle size, and a refractive index of the antibacterial composite of the present disclosure need to be controlled. In this way, the transparent antibacterial plastic film can have an antibacterial effect without changing its original optical properties.

In the present disclosure, the refractive index of the antibacterial composite ranges from 1.46 to 1.66. Preferably, the refractive index of the antibacterial composite ranges from 1.50 to 1.66. More preferably, the refractive index of the antibacterial composite ranges from 1.60 to 1.66. Even more preferably, the refractive index of the antibacterial composite ranges from 1.64 to 1.66. The refractive index of the antibacterial composite is measured according to the JIS K0062 standard.

In the present disclosure, the particle size of the antibacterial composite ranges from 20 nm to 700 nm. Preferably, the particle size of the antibacterial composite ranges from 40 nm to 600 nm. More preferably, the particle size of the antibacterial composite ranges from 50 nm to 400 nm.

Through adjusting the refractive index and the particle size of the antibacterial composite, the original optical properties (such as haze, transmittance, and refractive index) of the transparent antibacterial plastic film can be maintained. For example, when the transparent antibacterial plastic film is applied to a packaging for food or a protection mask for medical staff, visibility of the transparent antibacterial plastic film is an important feature. Hence, the transparent antibacterial plastic film needs to have a high transmittance and a low haze. When the transparent antibacterial plastic film is applied to a screen protector, in addition to the transmittance and the haze, the refractive index of the transparent antibacterial plastic film is also expected to meet a certain requirement.

In an exemplary embodiment, the haze of the transparent antibacterial plastic film is lower than or equal to 2.5%. Preferably, the haze of the transparent antibacterial plastic film is lower than or equal to 2.2%. More preferably, the haze of the transparent antibacterial plastic film is lower than or equal to 2.1%. In an exemplary embodiment, the transmittance of the transparent antibacterial plastic film is higher than or equal to 88%. Preferably, the transmittance of the transparent antibacterial plastic film is higher than or equal to 89%. More preferably, the transmittance of the transparent antibacterial plastic film is higher than or equal to 90%. In an exemplary embodiment, the refractive index of the transparent antibacterial plastic film ranges from 1.4 to 2.0. Preferably, the refractive index of the transparent antibacterial plastic film ranges from 1.5 to 1.9.

Based on a total weight of the transparent antibacterial plastic film being 100 wt %, an amount of the antibacterial composite ranges from 0.1 wt % to 2 wt %. Preferably, based on a total weight of the transparent antibacterial plastic film being 100 wt %, the amount of the antibacterial composite ranges from 0.1 wt % to 1.5 wt %. More preferably, based on a total weight of the transparent antibacterial plastic film being 100 wt %, the amount of the antibacterial composite ranges from 0.1 wt % to 1 wt %. Accordingly, the optical properties of the transparent antibacterial plastic film are not negatively influenced by the antibacterial composite, and a balance between the antibacterial effect and a production cost of the transparent antibacterial plastic film can be achieved.

The antibacterial composite of the present disclosure includes a nanopowder and an antiseptic. The nanopowder can be used as a carrier, such that the antiseptic can be attached onto the nanopowder. The antibacterial composite has a good heat resistance. Even at a processing temperature (260° C. to 290° C.) of a polyester material, the antibacterial composite does not crack or generate volatile substances.

A material of the nanopowder is silicate or phosphate. In an exemplary embodiment, the material of the nanopowder is selected from the group consisting of: sodium silicate, sodium aluminosilicate, calcium aluminosilicate, and aluminum phosphate. However, the present disclosure is not limited thereto.

The nanopowder has a particle size that is similar to or almost the same as the particle size of the antibacterial composite. In other words, the particle size of the nanopowder ranges from 20 nm to 700 nm. Preferably, the particle size of the nanopowder ranges from 40 nm to 600 nm. More preferably, the particle size of the nanopowder ranges from 50 nm to 400 nm.

The antiseptic contains a metal ion or a metal oxide. In other words, the antiseptic is an inorganic antiseptic, thereby having a good heat resistance and not generating the volatile substances. Specifically, the antiseptic contains at least one of silver, zinc, copper, and titanium as a component. Based on a total weight of the antibacterial composite being 100 wt %, the antiseptic contains 0 wt % to 10 wt % of silver, 0 wt % to 50 wt % of zinc, 0 wt % to 30 wt % of copper, and 0 wt % to 10 wt % of titanium.

In an exemplary embodiment, the antiseptic contains at least one of silver nitrate, silver acetate, silver sulfate, silver phosphate, zinc sulfate, zinc nitrate, zinc acetate, zinc oxide, copper sulfate, copper chloride, copper acetate, copper oxide, and titanium dioxide as a component. However, the present disclosure is not limited thereto. In another exemplary embodiment, the antiseptic contains at least two of silver nitrate, silver acetate, silver sulfate, silver phosphate, zinc sulfate, zinc nitrate, zinc acetate, zinc oxide, copper sulfate, copper chloride, copper acetate, copper oxide, and titanium dioxide as a component. Preferably, the antiseptic contains any three of silver nitrate, silver acetate, silver sulfate, silver phosphate, zinc sulfate, zinc nitrate, zinc acetate, zinc oxide, copper sulfate, copper chloride, copper acetate, copper oxide, and titanium dioxide. In a preferable embodiment, the antiseptic contains at least two components of silver phosphate, zinc oxide, and titanium dioxide as a component.

In a more preferable embodiment, the antiseptic contains silver phosphate, zinc oxide, and titanium dioxide. In addition, an amount of silver phosphate is 1.2 times to 2.8 times more than an amount of titanium dioxide. An amount of zinc oxide is 25 times to 35 times more than the amount of titanium dioxide. Preferably, the amount of silver phosphate is 1.5 times to 2.5 times more than the amount of titanium dioxide. The amount of zinc oxide is 28 times to 32 times more than the amount of titanium dioxide.

An addition of the antibacterial composite enables the transparent antibacterial plastic film to have the antibacterial effect. Specifically, the transparent antibacterial plastic film of the present disclosure has the antibacterial effects against Pneumobacillus, Escherichia coli, Staphylococcus aureus, Methicillin resistant staphylococcus aureus, Salmonellosis, and Pseudomonas aeruginosa. Specific antibacterial effects of the transparent antibacterial plastic film are illustrated below.

The transparent antibacterial plastic film of the present disclosure also has an antifungal effect. Specifically, the transparent antibacterial plastic film has the antifungal effect against Aspergillus niger, Penicillium pinophilum, Chaetomium globosum, Gliocldium virens, and Aureobasidium pullulans. Specific antifungal effects of the transparent antibacterial plastic film are illustrated below.

### Method for Manufacturing the Transparent Antibacterial Plastic Film

Referring to FIG. 2, a method for manufacturing the transparent antibacterial plastic film is provided. The method of the present disclosure includes steps of: sintering the nanopowder and an antibacterial precursor to form the antibacterial composite (step S1); mixing the polyester material and the antibacterial composite to form antibacterial masterbatches (step S2); and using the antibacterial masterbatches to form the transparent antibacterial plastic film (step S3).

In step S1, the nanopowder and the antibacterial precursor are sintered in a furnace. After sintering, the antiseptic is formed from the antibacterial precursor, and the antibacterial composite containing the antiseptic can be obtained. As mentioned previously, the material of the nanopowder can be silicate or phosphate. The antibacterial precursor contains at least one of silver, zinc, copper, and titanium as a component.

In an exemplary embodiment, the antibacterial precursor contains a metal ion, such as silver nitrate or zinc nitrate. The antiseptic is formed from the antibacterial precursor. Therefore, the antiseptic contains a metal component that is the same as that contained in the antibacterial precursor. In other words, the antiseptic contains at least one of silver, zinc, copper, and titanium as a component.

In an exemplary embodiment, the antibacterial precursor contains a metal oxide, such as zinc oxide. After sintering, the antibacterial precursor and the nanopowder still maintain their original composition. In other words, the antibacterial precursor and the antiseptic are the same.

After sintering, the particle size of the antibacterial composite ranges from 1 μm to 20 μm. In order to prevent the optical properties of the transparent antibacterial plastic film from being negatively influenced by the antibacterial composite, a purification step and a refinement step can be implemented, so that the particle size of the antibacterial composite can range from 20 nm to 700 nm, and the antibacterial composite can have a higher purity (more than 96%).

In step S2, after being uniformly mixed, the polyester material and the antibacterial composite can be put into an extruder to form the antibacterial masterbatches. In an exemplary embodiment, the polyester material can be at least one of polyethylene terephthalate, polytrimethylene terephthalate, polybutylene terephthalate, or any combination thereof. Preferably, the polyester material is a recycled polyester material, and more particularly a recycled polyethylene terephthalate.

In step S3, the antibacterial masterbatches are processed through a casting process to form the transparent antibacterial plastic film. The transparent antibacterial plastic film can be applied in various transparent products requiring the antibacterial effect.

### Antibacterial Effect Test

In order to prove the antibacterial effect, the transparent antibacterial plastic films of Examples 1 to 3 are prepared according to the above-mentioned method. A transparent plastic film without the antiseptic is prepared as Comparative Example 1. For one transparent antibacterial plastic film that is prepared as Comparative Example 2, the antiseptic is included but the refractive index of the antibacterial composite is higher than 1.66. Components of the transparent antibacterial plastic film in each of Examples 1 to 3 and Comparative Example 2 are listed in Table 1.

Visible light transmittance (VLT), haze, and antibacterial effect of the transparent antibacterial plastic films of Examples 1 to 3 and Comparative Example 2 and the transparent plastic film of Comparative Example 1 are measured and listed in Table 1. According to Table 1, the antibacterial effects against Escherichia coli and Staphylococcus aureus are measured according to the ISO 22196 standard. An antimicrobial activity (R value) higher than or equal to 2.0 indicates that there is a significant antibacterial effect.

TABLE 1

| | | | | | Comparative | |
|---|---|---|---|---|---|---|
| Transparent antibacterial plastic | | Example | | | Example | |
| film/transparent plastic film | | 1 | 2 | 3 | 1 | 2 |
| Amount of | Silver phosphate (wt %) | 0.016 | 0.008 | 0.000 | 0.000 | 0.016 |
| antiseptic | Zinc oxide (wt %) | 0.240 | 0.120 | 0.240 | 0.000 | 0.072 |
| in film | Titanium dioxide (wt %) | 0.008 | 0.004 | 0.008 | 0.000 | 0.176 |
| Refractive index of antibacterial | | 1.59 | 1.60 | 1.62 | — | 2.52 |
| composite | | | | | | |
| Amount of antibacterial composite | | 0.8 | 0.4 | 0.4 | 0.0 | 0.8 |
| in film (wt %) | | | | | | |
| Optical | VLT (%) | 90.08 | 90.53 | 90.12 | 91.08 | 86.26 |
| property | Haze (%) | 2.01 | 1.14 | 1.91 | 1.06 | 4.79 |
| | Refractive index | 1.60 | 1.59 | 1.58 | 1.58 | 1.58 |
| R value | Escherichia coli | >6.24 | 4.16 | 1.87 | 0.08 | 5.09 |
| | Staphylococcus aureus | >4.24 | 2.90 | 1.08 | 0.04 | 3.12 |

According to Table 1, the transparent antibacterial plastic film of the present disclosure (Examples 1 to 3) has the antibacterial effects against Escherichia coli and Staphylococcus aureus. In spite of the addition of the antibacterial composite, the optical properties (transmittance and haze) of the transparent antibacterial plastic film can still be maintained and is not negatively influenced.

Further, the optical properties of the transparent antibacterial plastic film can be adjusted according to various requirements. When a higher requirement is placed on the antibacterial effect of the transparent antibacterial plastic film, the amount of the antibacterial composite can be increased. Under this condition, the visible light transmittance of the transparent antibacterial plastic film can range from 88% to 90.5%, and the haze of the transparent antibacterial plastic film can range from 1.9% to 2.2%. On the other hand, when a higher requirement is placed on the optical properties of the transparent antibacterial plastic film, the optical properties can be maintained by only adding an appropriate amount of the antibacterial composite. Under this condition, the visible light transmittance of the transparent antibacterial plastic film can range from 90.5% to 92%, and the haze of the transparent antibacterial plastic film can range from 0.8% to 1.9%.

According to the results of Examples 1 to 3, when the antibacterial composite contains various kinds of the antiseptic (especially when silver phosphate, zinc oxide, and titanium dioxide are contained at the same time), the transparent antibacterial plastic film can have a good antibacterial effect.

According to the result of Comparative Example 2, when the refractive index of the antibacterial composite is beyond a range from 1.46 to 1.66, the transparent antibacterial plastic film can have a fair antibacterial effect but cannot have a haze lower than or equal to 2.2%.

The transparent antibacterial plastic film of Example 2 is further delivered to a certification center for an antibacterial effect test and an antifungal test.

In the antibacterial effect test, the antibacterial effect against Escherichia coli and Staphylococcus aureus are measured according to the ISO 22196 standard, and the antibacterial effect against Salmonellosis, Pneumobacillus, Methicillin resistant staphylococcus aureus, and Pseudomonas aeruginosa are measured according to the JIS Z2801 standard. The results of the antibacterial effect test are listed in Table 2. An antimicrobial activity (R value) higher than or equal to 2.0 indicates that there is a significant antibacterial effect.

TABLE 2

| | Antimicrobial activity |
|---|---|
| Bacteria | (R value) |
| Pneumobacillus | >5.76 |
| Escherichia coli | 4.16 |
| Staphylococcus aureus | 2.90 |
| Methicillin resistant staphylococcus aureus | 3.60 |
| Salmonellosis | 2.59 |
| Pseudomonas aeruginosa | >5.10 |

According to the results in Table 2, the antimicrobial activities are all higher than 2. That is, the transparent antibacterial plastic film of the present disclosure has a good antibacterial effect. It is worth mentioning that the transparent antibacterial plastic film of the present disclosure has an outstanding antibacterial effect against Pneumobacillus and Pseudomonas aeruginosa.

In the antifungal test, the antifungal effects against Aspergillus niger, Penicillium pinophilum, Chaetomium globosum, Gliocldium virens, and Aureobasidium pullulans are measured according to the ASTM G21 standard, and the results are listed in Table 3. According to the ASTM G21 standard, a rating of 0 indicates that there is no fungal growth; a rating of 1 indicates that there is a light fungal growth (an area of fungal growth<10%); a rating of 2 indicates that there is a mild fungal growth (an area of fungal growth ranging from 10% to 30%); a rating of 3 indicates that there is a moderate fungal growth (an area of fungal growth ranging from 30% to 60%); and a rating of 4 indicates that there is a heavy fungal growth (an area of fungal growth>60%).

TABLE 3

| Fungi | Antifungal effect |
|---|---|
| Aspergillus niger | a rating of 0 (highest grade): no fungal growth |
| Penicillium pinophilum | a rating of 0 (highest grade): no fungal growth |
| Chaetomium globosum | a rating of 0 (highest grade): no fungal growth |
| Gliocldium virens | a rating of 0 (highest grade): no fungal growth |
| Aureobasidium pullulans | a rating of 0 (highest grade): no fungal growth |

According to the results in Table 3, the transparent antibacterial plastic film of the present disclosure can inhibit fungal growth. The fungi listed in Table 3 cannot grow on the transparent antibacterial plastic film of the present disclosure.

### Application of Transparent Antibacterial Plastic Film

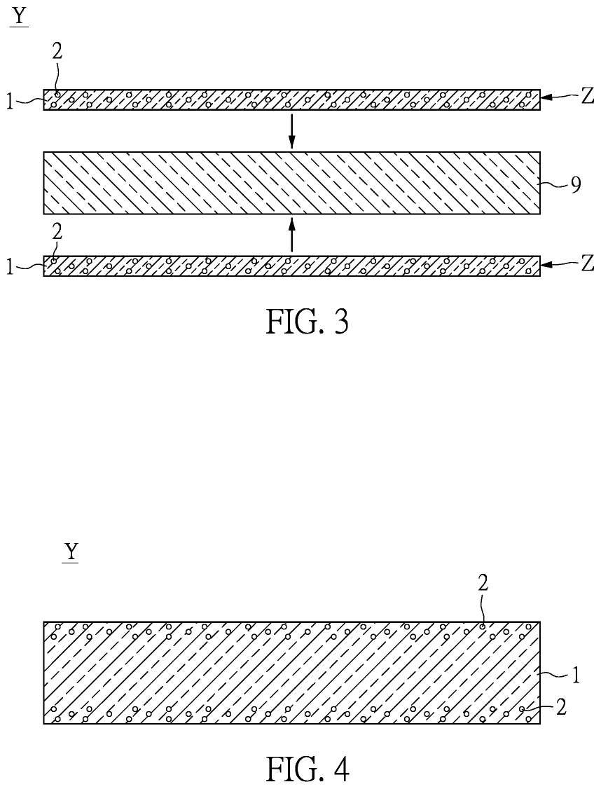

Referring to FIG. 3, the transparent antibacterial plastic film Z of the present disclosure can be laminated on a substrate 9 to form a transparent antibacterial substrate Y. The transparent antibacterial plastic film Z can be disposed on each of two opposite surfaces of the substrate 9. Therefore, the substrate 9 can have the antibacterial effect and the antifungal effect. The transparent antibacterial plastic film Z includes the polyester material 1 and the antibacterial composite 2 that are similar to those mentioned previously, and will not be reiterated herein.

In an exemplary embodiment, a material of the substrate 9 is polyester, and the material of the substrate 9 is the same as or similar to the polyester material 1 of the transparent antibacterial plastic film Z. Accordingly, the two transparent antibacterial plastic films Z and the substrate 9 can be formed integrally, so as to form the transparent antibacterial substrate Y as shown in FIG. 4.

Referring to FIG. 4, the transparent antibacterial substrate Y is formed from the two transparent antibacterial plastic films Z and the substrate 9, such that the antibacterial composite 2 is distributed on two surficial regions of the transparent antibacterial substrate Y, rather than uniformly dispersed in the transparent antibacterial substrate Y. Therefore, under the condition that the antibacterial effect of the transparent antibacterial substrate Y is not negatively influenced, a usage of the antibacterial composite 2 can be reduced, thereby lowering the production cost.

### Beneficial Effects of the Embodiments

In conclusion, in the transparent antibacterial plastic film and the method for manufacturing the same provided by the present disclosure, by virtue of “the antibacterial composite being dispersed in the polyester material” and “the refractive index of the antibacterial composite ranging from 1.46 to 1.66”, the transparent antibacterial plastic film can simultaneously have the antibacterial effect and its original optical properties.

Further, by virtue of “the particle size of the antibacterial composite ranging from 50 nm to 400 nm”, the transparent antibacterial plastic film can simultaneously have the antibacterial effect and the original optical properties.

Further, by virtue of “based on the total weight of the transparent antibacterial plastic film being 100 wt %, the amount of the antibacterial composite ranging from 0.1 wt % to 2 wt %”, the transparent antibacterial plastic film can simultaneously have the antibacterial effect and the original optical properties.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A transparent antibacterial plastic film, comprising:
a polyester material; and
an antibacterial composite dispersed in the polyester material, wherein a refractive index of the antibacterial composite ranges from 1.46 to 1.66.

2. The transparent antibacterial plastic film according to claim 1, wherein a particle size of the antibacterial composite ranges from 50 nm to 400 nm.

3. The transparent antibacterial plastic film according to claim 1, wherein, based on a total weight of the transparent antibacterial plastic film being 100 wt %, an amount of the antibacterial composite ranges from 0.1 wt % to 2 wt %.

4. The transparent antibacterial plastic film according to claim 1, wherein the antibacterial composite includes a nanopowder and an antiseptic, and the antiseptic is an inorganic antiseptic.

5. The transparent antibacterial plastic film according to claim 4, wherein the nanopowder is selected from the group consisting of: sodium silicate, sodium aluminosilicate, calcium aluminosilicate, and aluminum phosphate.

6. The transparent antibacterial plastic film according to claim 4, wherein the antiseptic contains at least one of silver, zinc, copper, and titanium as a component.

7. The transparent antibacterial plastic film according to claim 6, wherein, based on a total weight of the antibacterial composite being 100 wt %, the antiseptic contains 0 wt % to 10 wt % of silver, 0 wt % to 50 wt % of zinc, 0 wt % to 30 wt % of copper, and 0 wt % to 10 wt % of titanium.

8. The transparent antibacterial plastic film according to claim 1, wherein a haze of the transparent antibacterial plastic film is lower than or equal to 2.2%, a transmittance of the transparent antibacterial plastic film is higher than or equal to 88%, and a refractive index of the transparent antibacterial plastic film ranges from 1.5 to 1.9.

9. A method for manufacturing a transparent antibacterial plastic film, comprising:
mixing a polyester material and an antibacterial composite to form antibacterial masterbatches; and
using the antibacterial masterbatches to form the transparent antibacterial plastic film;
wherein a refractive index of the antibacterial composite ranges from 1.46 to 1.66.

10. The method according to claim 9, further comprising:
sintering a nanopowder and an antibacterial precursor to form the antibacterial composite;
wherein the antibacterial composite includes the nanopowder and an antiseptic, the antiseptic is formed from the antibacterial precursor, and the antiseptic and the antibacterial precursor contain a same metal component.
